(19) United States
(12) Patent Application Publication
(10) Pub. No.: US 2012/0250039 A1
(43) Pub. Date: Oct. 4, 2012

(54) SYSTEM AND METHOD FOR PRESENTING INFORMATION TO A USER

(76) Inventors: Arthur Austin Ollivierre, San Francisco, CA (US); Robert Michael DiNapoli, San Francisco, CA (US)

(21) Appl. No.: 13/167,234

(22) Filed: Jun. 23, 2011

Related U.S. Application Data
(63) Continuation-in-part of application No. 13/078,661, filed on Apr. 1, 2011.

(51) Int. Cl. G06K 15/02; G06F 17/30; G06F 3/048

(52) U.S. Cl. 358/1.6; 715/764; 715/274; 235/380

(57) ABSTRACT

A system, computer-readable storage medium storing at least one program, and a computer-implemented method for presenting information to a user are presented. Information to be presented to the user is received, where the information has a predetermined format. An identifier for the user is obtained. A visual acuity for the user is obtained using the identifier for the user. The predetermined format is adjusted based on the visual acuity of the user to produce an adjusted format. The information is presented to the user using the adjusted format.

### RELATED APPLICATION

This application is a continuation-in-part of and claims the benefit of priority under 35 U.S.C. §120 to U.S. patent application Ser. No. 13/078,661, filed on Apr. 1, 2011, which is hereby incorporated by reference herein in its entirety.

### TECHNICAL FIELD

The disclosed embodiments relate generally to techniques for presenting information to a user.

### BACKGROUND

Many people have issues with vision that inhibit them from being able to see information presented to them on electronic devices and/or printed media. Glasses or contact lenses may allow users that are nearsighted or farsighted to see this information. However, users may not be wearing their glasses or contact lenses at the time that this information is being presented. Furthermore, some users may have vision issues that are not correctable using glasses or contact lenses.

### BRIEF DESCRIPTION OF THE DRAWINGS

The embodiments disclosed herein are illustrated by way of example, and not by way of limitation, in the figures of the accompanying drawings. Like reference numerals refer to corresponding parts throughout the drawings.

FIG. 1 is a block diagram illustrating a system, according to some embodiments.

FIG. 2 is a block diagram illustrating a device, according to some embodiments.

FIG. 3 is a flowchart of a method for presenting information to a user, according to some embodiments.

FIG. 4 is a flowchart of a method for presenting information to a user using an adjusted format, according to some embodiments.

FIG. 5 is a flowchart of a method for identifying print settings based on the visual acuity of a user, according to some embodiments.

FIG. 6 is a flowchart of a method for printing the objects corresponding to information to be presented to the user on the document based on print settings, according to some embodiments.

FIG. 7 is a flowchart of a method for printing objects corresponding to information to be presented to a user on a document based on print settings using, according to some embodiments.

FIG. 8 is a flowchart of a method for presenting information to a user using an adjusted format, according to some embodiments.

FIG. 9 is a flowchart of a method identifying display settings based on a visual acuity of a user, according to some embodiments.

FIG. 10 is a flowchart of a method for displaying objects corresponding to information to be presented to a user in a graphical user interface of a device based on display settings, according to some embodiments.

FIG. 11 is a flowchart of a method for displaying objects in the viewable area of the graphical user interface, according to some embodiments.

FIG. 12 is a flowchart of another method for displaying objects in the viewable area of the graphical user interface, according to some embodiments.

FIG. 13 is a block diagram illustrating an example machine for performing the methodologies described herein, according to some embodiments.

### DESCRIPTION OF EXAMPLE EMBODIMENTS

The description that follows includes example systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures and techniques have not been shown in detail.

Some embodiments provide techniques for presenting information to a user. Information to be presented to the user is received, where the information has a predetermined format. An identifier for the user is obtained. A visual acuity for the user is obtained using the identifier for the user. The predetermined format is adjusted based on the visual acuity of the user to produce an adjusted format. The information is presented to the user using the adjusted format.

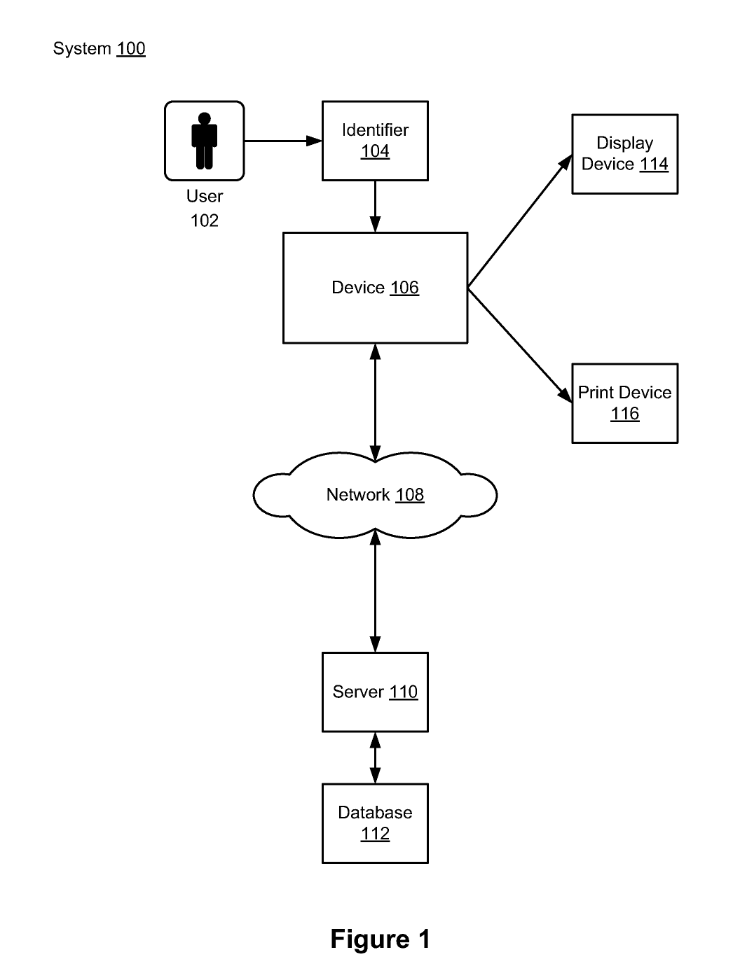

FIG. 1 is a block diagram illustrating a system 100, according to some embodiments. The system 100 may include a device 106 coupled to a network 108. The device 106 may include, but is not limited to: a point-of-sale device, a kiosk, a cell phone, a smartphone, a personal computer, a telephone, a hand held computer, an electronic tablet, and the like.

The device 106 may be used to present information (e.g., text, images) to a user 102 using a display device 114 and/or a printout printed using a print device 116. The information presented to the user 102 that is displayed on the display device 114 may include, but is not limited to: displaying a signature line for the user 102 to sign on a graphical user interface of a point of sale device, displaying an option asking the user 102 to confirm payment with a credit card on the graphical user interface of the point of sale device, displaying a heart rate for the user 102 on the graphical user interface of a measuring device, and/or the like. The information presented to the user 102 that is printed on the print device may include, but is not limited to: a customer receipt for the user 102, a brochure, a letter, a bank account statement for the user 102, and the like.

The information to be presented to the user 102 may have a predetermined format. For example, a receipt printed by a printer of a point-of-sale device may have a predetermined font size (e.g., 12 point font) and orientation (e.g., portrait orientation). However, some users may not be able to see the information presented in the predetermined font size because the predetermined font size may be too small for the users to see. Thus, in some embodiments, the device 106 uses a visual acuity for the user 102 to adjust the information to be presented to the user 102 so that the user 102 can see the information. Note that the visual acuity of the user 102 corresponds to an ability of the user 102 to see information presented to the user 102. The device 106 may also use the visual acuity for the user 102 to adjust only a portion of the information to be presented to the user 102 so that the user 102 can see the portion of the information that was adjusted.

The device 106 may adjust the information to be presented to the user 102 by first determining the visual acuity of the user 102 and, if necessary, adjusting a predetermined format of the information to be presented to the user 102 using the visual acuity of the user 102. If the device 106 determines that the ability of the user 102 to see the information to be presented to the user 102 may be improved, then device 106 may adjust the predetermined format of the information so that the user 102 can see the information to be presented to the user 102. For example, the device 106 may adjust the predetermined format by rotating the information and increasing a size of the information (e.g., font size, image size) thereby improving the ability of the user 102 to see the information to be presented to the user 102. Similarly, the device 106 may adjust the predetermined format of the information to be presented to the user 102 by scaling the information (e.g., increasing font size, increasing image size) thereby improving the ability of the user 102 to see the information to be presented to the user 102.

The device 106 may adjust a portion of the predetermined format for the information to be presented to the user 102. For example, if it is determined that the user 102 has trouble seeing a total line on a receipt, the device 106 may scale only the total line (e.g., scaling a font size for the total line from 12 point to 14 point), making the total more visible to the user 102. Similarly, the device 106 may rotate only the total line and increase a font size of only the total line so that the total line is more visible to the user 102. This adjustment may be done by making the total line occupy the length of the receipt rather than the width of the receipt.

Note that the device 106 may cause the print device 116 to print the information to be presented to the user 102 in the adjusted format or in the predetermined format based on the visual acuity of the user 102. Similarly, the device 106 may cause the display device 114 to display the information to be presented to the user 102 in the adjusted format or in the predetermined format based on the visual acuity of the user 102.

In some embodiments, the visual acuity of the user 102 is stored in a database 112 coupled to a server 110 (e.g., coupled via the network 108, via another network, via a direct connection). As illustrated in FIG. 1, the server 110 may be coupled to the network 108. The server 110 may include, but is not limited to: a server for a credit card processor, a server for a credit card issuer, or a server for a website that tests and/or stores visual acuity for users. The database 112 may associate the visual acuities of the users 102 (and other users) with an identifier 104 for the user 102 (or corresponding identifiers for respective users). For example, visual acuities of users in the database 112 may be organized into a table with unique identifiers for the users (e.g., social security numbers, credit card numbers) being the primary key and occupying a first column of the table. The table may also include an additional column storing the visual acuities corresponding to each unique identifier in the first column. A table lookup may then be used to retrieve the visual acuity for a user using the unique identifier for the user (e.g., a social security number for the user). In some embodiments, the database 112 is a distributed database (e.g. geographically distributed and/or distributed within a data center, etc.). In some embodiments, the database 103 is a relational database.

As discussed above, the identifier 104 may be associated with the user 102. The identifier 104 for the user 102 may include information that may be used to identify the user 102. For example, the identifier for the user 102 may include, but is not limited to: a social security number of the user 102, a personal identification number (PIN) of the user 102, a birth date of the user 102, a credit card number of the user 102, a debit card number of the user 102, a bank account number of the user 102, biometrics of the user 102, or other unique characteristics of the user 102.

The identifier 104 for the user 102 may be included on a personal identification object for the user 102. A personal identification object of the user 102 may include, but is not limited to: a credit card for the user 102, a driver's license for the user 102, a cellular phone of the user 102, a smartphone of the user 102, and an RFID tag for the user 102.

The device 106 may use the personal identification object to identify the user 102 so that the visual acuity of the user may be determined. For example, if the device 106 is a point-of-sale device that the user 102 is using to pay for goods or services, the device 106 may use the personal identification object of the user 102 to obtain the identifier 104 of the user 102. In some embodiments, the device 106 obtains the identifier 104 for the user 102 from the personal identification object. The identifier 104 for the user 102 may be obtained from the personal identification object using several techniques. For example, these techniques include, but are not limited to: reading a magnetic stripe of a credit card for the user 102 using a magnetic stripe reader, reading a magnetic stripe of a driver's license for the user 102 using a magnetic stripe reader, scanning an RFID tag for the user 102 using an RFID reader, and/or the like.

In some cases, the device 106 may obtain the identifier 104 for the user 102 from the user 102. For example, if the device 106 is a point-of-sale device that the user 102 is using to pay for goods or services, the device 106 may include a keypad for the user 102 to type in the identifier 104 (e.g., a PIN, a credit card number, a user name and/or password) for the user 102. As another example, if the device 106 is a device that can obtain the identifier 104 of the user from a voice of the user (e.g., a device with voice command features, a telephone, a smartphone, a kiosk, and/or the like), the device 106 may use the voice of the user 102 to obtain the identifier 104 for the user 102.

After the device 106 has obtained the identifier 104 for the user 102, the device 106 may use the identifier 104 to obtain the visual acuity for the user 102. For example, the device 106 may use the identifier 104 for the user 102 to query the database 112 for the visual acuity for the user 102.

Note that although system 100 in FIG. 1 shows one instance for each of the user 102, the identifier 104, the device 106, the network 108, the server 110, the database 112, the display device 114, and the print device 116, multiple users, identifiers, devices, networks, servers, databases, display devices, and print devices may be present in the system 100. For example, the system 100 may include two instances of the user 102 each of them using one instance of the device 106, resulting in a total of two instances of the device 106. The system 100 may also include two instances of the device 106 coupled to the network 108. The system may also include two instances of the device 106 each coupled to a different instance of the network 108, resulting in two instances of the network 108.

Also note that although the embodiments described herein refer to the user 102, the identifier 104, the device 106, the network 108, the server 110, the database 112, the display device 114, and the print device 116, the embodiments may be applied to multiple users, identifiers, devices, networks, servers, databases, display devices, and print devices may be present in the system 100.

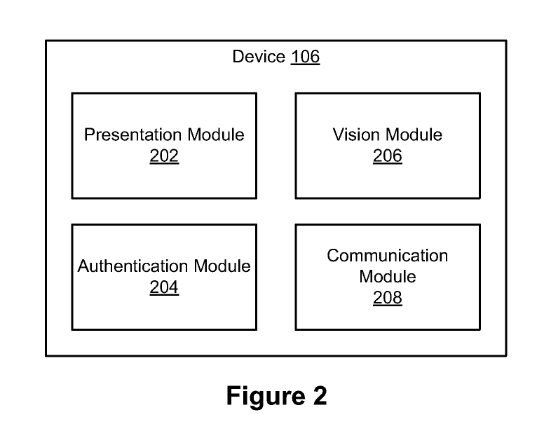

FIG. 2 is a block diagram illustrating the device 106, according to some embodiments. The device 106 may include a presentation module 202, an authentication module 204, a vision module 206, and a communication module 208. The presentation module 302 is configured to present the information to the user based on a visual acuity of the user. The authentication module 204 is configured to obtain an identifier 104 for the user. The vision module 206 is configured to obtain the visual acuity for the user using the identifier 104 for the user 102 and adjust a predetermined format of the information to be presented to the user 102 based on the visual acuity of the user 102. The communication module 208 is configured to transmit and/or receive data and/or commands from other computer systems via network 108.

### Presenting Information to Users

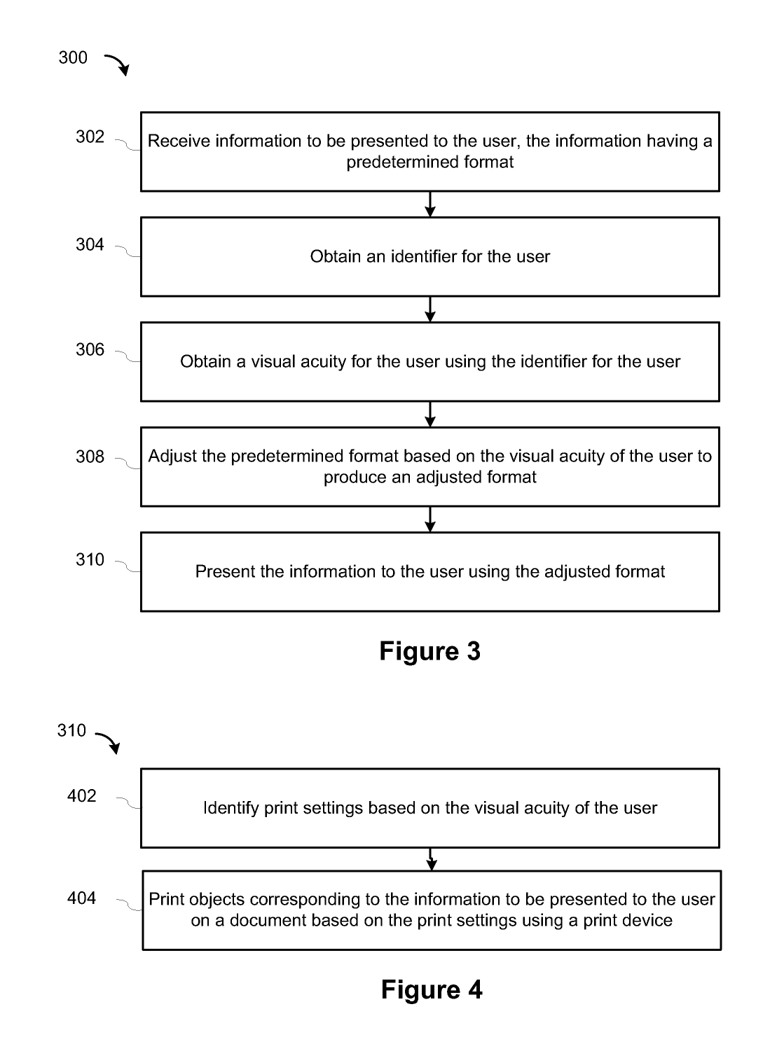

FIG. 3 is a flowchart of a method 400 for presenting the information to the user 102, according to some embodiments. The presentation module 202 receives information to be presented to the user (operation 302), where the information has a predetermined format. As discussed above, the predetermined format may include a default font style, a default font size, a default orientation, and the like.

The authentication module 204 obtains an identifier for a user (e.g., the identifier 104 for the user 102) (operation 304). As discussed above, the identifier for the user may be obtained from the user or from the personal identification object for the user.

In some embodiments, the identifier for the user is included on a personal identification object. In these embodiments, when obtaining the identifier for the user, the authentication module 204 obtains electronic data including the identifier for the user from the personal identification object. In some embodiments, when obtaining the electronic data including the identifier for the user from the personal identification object, the authentication module 204 obtains the identifier for the user from the magnetic stripe of the credit card using a magnetic stripe reader. In some embodiments, when obtaining the electronic data including the identifier for the user from the personal identification object, the authentication module 204 obtains the identifier for the user from the magnetic stripe of the driver's license using a magnetic stripe reader. In some embodiments, when obtaining the electronic data including the identifier for the user from the personal identification object, the authentication module 204 obtains the identifier for the user from the RFID tag using an RFID reader.

The vision module 206 obtains the visual acuity for the user using the identifier for the user 102 (operation 306). As discussed above, the visual acuity for the user may be obtained from the database 112.

The vision module 206 adjusts the predetermined format based on the visual acuity of the user 102 to produce an adjusted format (operation 308). For example, the vision module 206 may adjust the predetermined format of the information by rotating the information and increasing a size of the information (e.g., font size, image size) thereby improving the ability of the user 102 to see the information to be presented to the user 102. Similarly, the vision module 206 may adjust the predetermined format of the information to be presented to the user 102 by scaling the information (e.g., increasing font size, increasing image size) thereby improving the ability of the user 102 to see the information to be presented to the user 102.

The presentation module 202 presents the information to the user using the adjusted format (operation 310). Operation 310 is described in more detail below with reference to FIG. 4, which relates to presenting information on a printed document, and FIG. 8, which relates to presenting information on a display device.

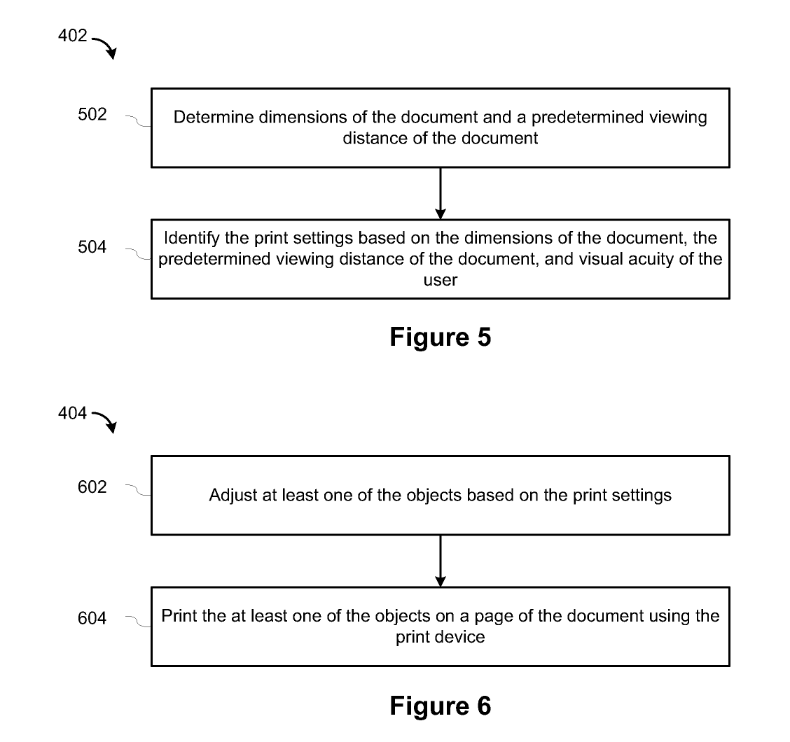

Information Presented on a Printout FIG. 4 is a flowchart of a method for presenting the information to the user using the adjusted format (e.g., operation 310), according to some embodiments. The presentation module 202 identifies print settings based on the visual acuity of the user (operation 402). The print settings may be used by the presentation module 202 to instruct (or configure) the print device 116 to print the information to be presented to the user in a particular format. Note that the print settings may include default print settings (e.g., print settings for the predetermined format) and adjusted print settings (e.g., print settings for the adjusted format). The print settings may include, but are not limited to: size of the information, an orientation of the information, and the like. For example, the presentation module 202 may determine that the visual acuity of the user is not sufficient to see the information to be presented to the user in a default format. The presentation module 302 may then identify print settings that will allow the user to see the information. For example, the presentation module 202 may identify print settings that increase font size and/or orientation of text. Operation 402 is described in more detail with reference to FIG. 5.

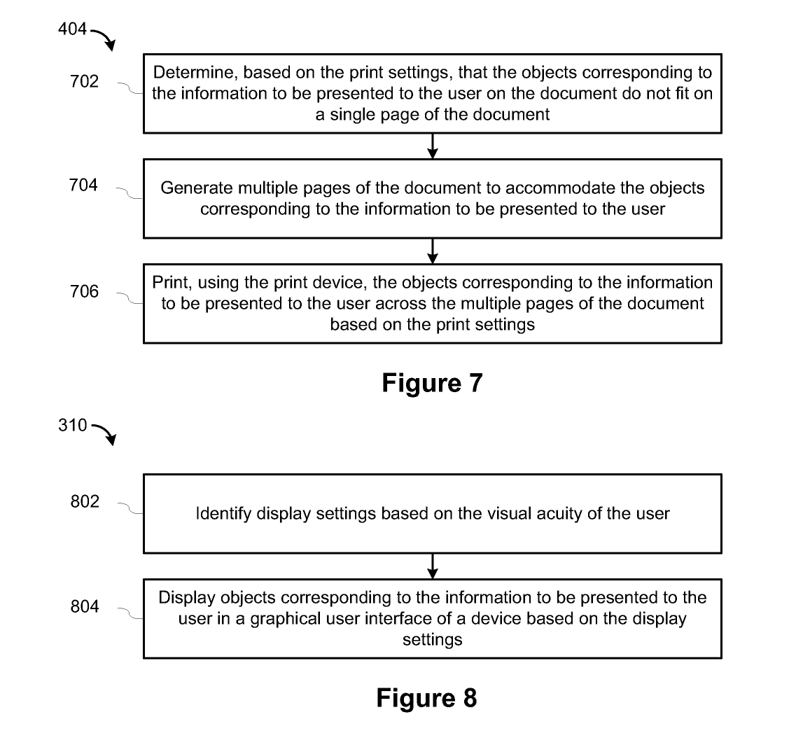

The presentation module 202 prints objects corresponding to the information to be presented to the user on a document based on the print settings using the print device 116 (operation 404). For example, the presentation module 202 may cause the print device 116 to print the information to be presented to the user 102 using a larger font and/or using a landscape orientation. Note that an object corresponding to the information to be presented may include, but is not limited to, email, text, web pages, images, and the like. Operation 404 is described in more detail with reference to FIGS. 6 and 7.

FIG. 5 is a flowchart of a method for identifying print settings based on the visual acuity of a user (e.g., operation 402), according to some embodiments. The presentation module 202 determines dimensions of the document and a predetermined viewing distance of the document (operation 502). The presentation module 202 may determine the dimensions of the document (e.g., 8.5″×11″). The presentation module 202 may determine a predetermined viewing distance of the document (e.g., by retrieving information regarding the predetermined viewing distance of the document corresponding to the dimensions of the document). For example, the presentation module 202 may determine that the predetermined viewing distance of the 8.5″×11″ piece of paper is 12″.

The device 106 identifies the print settings based on the dimensions of the document, the predetermined viewing distance of the document, and visual acuity of the user (operation 504). For example, the presentation module 202 may determine that the information to be presented to the user should be printed using 18 point font so that the user can see the information printed on an 8.5″×11″ piece of paper that is held 12″ from the user's eyes.

FIG. 6 is a flowchart of a method for printing the objects corresponding to information to be presented to the user on the document based on print settings, according to some embodiments. The presentation module 202 adjusts at least one of the objects based on the print settings (operation 602) and prints the at least one of the objects on a page of the document using the print device (operation 604). These embodiments address the situation in which a user may only be interested in particular portions of the information. For example, on a restaurant food check, the user may only be interested in the subtotal or total lines. In some embodiments, the document includes a customer receipt printed during a sale transaction. In these embodiments, when adjusting the at least one of the objects based on the print settings, the presentation module 202 adjusts an object on the receipt that includes information important to the user. In some embodiments, the object on the receipt that includes information important to the user is selected from the group consisting of a total value line of the receipt and a customer signature line of the receipt.

FIG. 7 is a flowchart of a method for printing objects corresponding to information to be presented to a user on a document based on print settings, according to some embodiments. The presentation module 202 determines, based on the print settings, that the objects corresponding to the information to be presented to the user on the document do not fit on a single page of the document (operation 702). The presentation module 202 generates multiple pages of the document to accommodate the objects corresponding to the information to be presented to the user (operation 704). The presentation module 202 prints, using the print device, the objects corresponding to the information to be presented to the user across the multiple pages of the document based on the print settings (operation 706).

### Information Presented on a Display Device

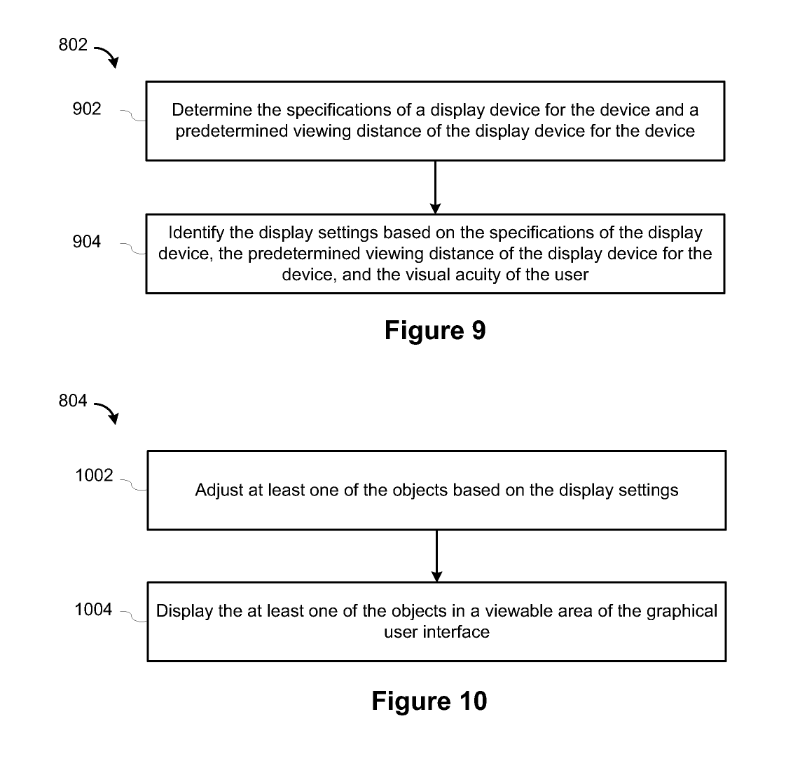

FIG. 8 is a flowchart of a method for presenting the information to the user using the adjusted format (e.g., operation 310), according to some embodiments. The presentation module 202 identifies display settings based on the visual acuity of the user (operation 802) and displays objects corresponding to the information to be presented to the user in a graphical user interface of a device based on the display settings (operation 804). Operation 802 is described in more detail with reference to FIG. 9 and operation 804 is described in more detail with reference to FIG. 10.

FIG. 9 is a flowchart of a method identifying display settings based on a visual acuity of a user (e.g., operation 802), according to some embodiments. The presentation module 202 determines the specifications of a display device for the device and a predetermined viewing distance of the display device for the device (operation 902). For example, the presentation module 202 may determine that the display device for the device is a 23″ monitor having a resolution of 2048×1152 and a predetermined viewing distance of 12″.

The presentation module 202 identifies the display settings based on the specifications of the display device, the predetermined viewing distance of the display device for the device, and the visual acuity of the user (operation 904). For example, the presentation module 202 may determine that a 24 point font size should be used to display the information to the user, based on the visual acuity of the user.

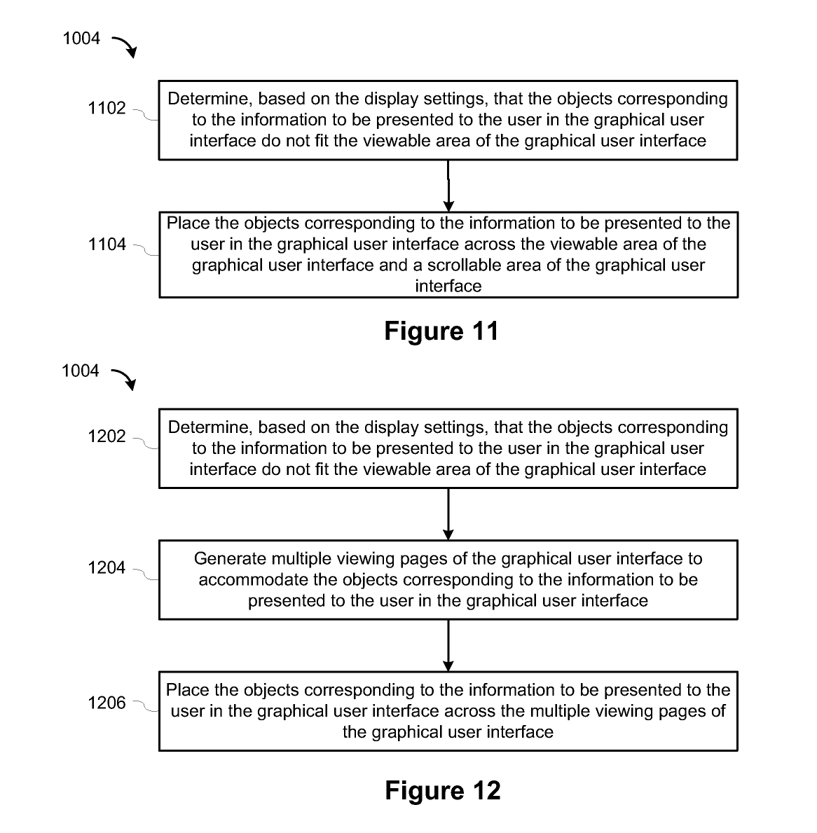

FIG. 10 is a flowchart of a method for displaying objects corresponding to information to be presented to a user in a graphical user interface of a device based on display settings (e.g., operation 804), according to some embodiments. The presentation module 202 adjusts at least one of the objects based on the display settings (operation 1002) and displays (operation 1004) the at least one of the objects in a viewable area of the graphical user interface. As discussed above, a user may only be interested in a portion of the information (e.g., a total line displayed on a display device for a point-of-sale device). Operation 1004 is described in more detail with reference to FIGS. 11 and 12.

FIG. 11 is a flowchart of a method for displaying objects in the viewable area of the graphical user interface (e.g., operation 1004), according to some embodiments. The presentation module 202 determines, based on the display settings, that the objects corresponding to the information to be presented to the user in the graphical user interface do not fit the viewable area of the graphical user interface (operation 1102). The presentation module 202 places the objects corresponding to the information to be presented to the user in the graphical user interface across the viewable area of the graphical user interface and a scrollable area of the graphical user interface (operation 1104). For example, if the presentation module 202 increases the font so that the user can see text presented on the display device, it may be necessary to place some of the information to be presented outside of a viewable area of the user interface for the display device. The user may access the information placed outside of the viewable area of the display device by using, for example, scroll bars, displayed in the user interface.

FIG. 12 is a flowchart of a method for displaying objects in the viewable area of the graphical user interface (e.g., operation 1004), according to some embodiments. The presentation module 202 determines, based on the display settings, that the objects corresponding to the information to be presented to the user in the graphical user interface do not fit the viewable area of the graphical user interface (operation 1202). The presentation module 202 generates multiple viewing pages of the graphical user interface to accommodate the objects corresponding to the information to be presented to the user in the graphical user interface (operation 1204). The presentation module 202 places the objects corresponding to the information to be presented to the user in the graphical user interface across the multiple viewing pages of the graphical user interface (1206). For example, some graphical user interfaces for devices use a concept of “pages” to present information and/or controls. If, for example, the presentation module 202 increases a font size of information to be presented, this information may not fit on a single page of the graphical user interface. Thus, the presentation module 202 may create additional pages to place information that cannot be displayed on a single page of the graphical user interface.

### Example Machine

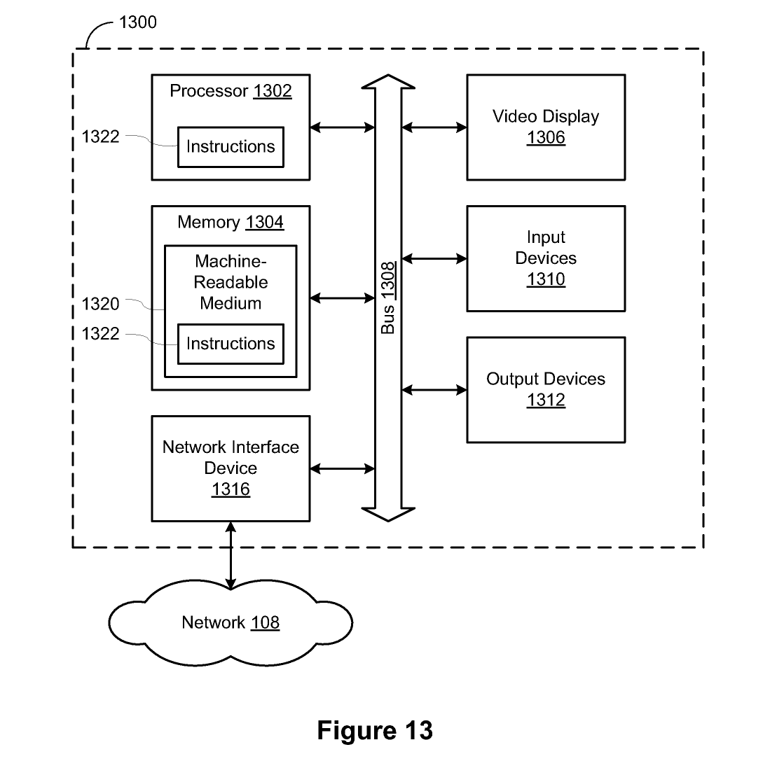

FIG. 13 depicts a block diagram of a machine in the example form of a computer system 1300 within which may be executed a set of instructions for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in a server-client network environment or as a peer machine in a peer-to-peer (or distributed) network environment. The computer system 1300 may include, but is not limited to, a desktop computer system, a laptop computer system, a server, a mobile phone, a smart phone, a personal digital assistant (PDA), a gaming console, a portable gaming console, a set top box, a camera, a printer, a television set, or any other electronic device.

The machine is capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example of the computer system 1300 includes a processor 1302 (e.g., a central processing unit (CPU), a graphics processing unit (GPU) or both), and memory 1304, which communicate with each other via bus 1308. Memory 1304 includes volatile memory devices (e.g., DRAM, SRAM, DDR RAM, or other volatile solid state memory devices), non-volatile memory devices (e.g., magnetic disk memory devices, optical disk memory devices, flash memory devices, tape drives, or other non-volatile solid state memory devices), or a combination thereof. Memory 1304 may optionally include one or more storage devices remotely located from the computer system 1300. The computer system 1300 may further include a video display unit 1306 (e.g., a plasma display, a liquid crystal display (LCD) or a cathode ray tube (CRT)). The computer system 1300 also includes input devices 1310 (e.g., keyboard, mouse, trackball, touchscreen display, etc.), output devices 1312 (e.g., speakers), and a network interface device 1316. The aforementioned components of the computer system 1300 may be located within a single housing or case (e.g., as depicted by the dashed lines in FIG. 13). Alternatively, a subset of the components may be located outside of the housing. For example, the video display unit 1306, the input devices 1310, and the output devices 1312 may exist outside of the housing, but be coupled to the bus 1308 via external ports or connectors accessible on the outside of the housing.

Memory 1304 includes a machine-readable medium 1320 on which is stored one or more sets of data structures and instructions 1322 (e.g., software programs) embodying or utilized by any one or more of the methodologies or functions described herein. The one or more sets of data structures may store data. Note that a machine-readable medium refers to a storage medium that is readable by a machine (e.g., a computer-readable storage medium). The data structures and instructions 1322 may also reside, completely or at least partially, within memory 1304 and/or within the processor 1302 during execution thereof by computer system 1300, with memory 1304 and processor 1302 also constituting machine-readable, tangible media.

The data structures and instructions 1322 may further be transmitted or received over a network 108 via network interface device 1316 utilizing any one of a number of well-known transfer protocols (e.g., HyperText Transfer Protocol (HTTP)). The network 108 can generally include any type of wired or wireless communication channel capable of coupling together computing nodes. This includes, but is not limited to, a local area network (LAN), a wide area network (WAN), or a combination of networks. In some embodiments, network 120 includes the Internet.

Certain embodiments are described herein as including logic or a number of components, modules, or mechanisms. Modules may constitute either software modules (e.g., code and/or instructions embodied on a machine-readable medium or in a transmission signal) or hardware modules. A hardware module is a tangible unit capable of performing certain operations and may be configured or arranged in a certain manner. In example embodiments, one or more computer systems (e.g., the computer system 1300) or one or more hardware modules of a computer system (e.g., a processor 1302 or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a processor 1302 or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a processor 1302 configured using software, the processor 1302 may be configured as respective different hardware modules at different times. Software may accordingly configure a processor 1302, for example, to constitute a particular hardware module at one instance of time and to constitute a different hardware module at a different instance of time.

Modules can provide information to, and receive information from, other modules. For example, the described modules may be regarded as being communicatively coupled. Where multiples of such hardware modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices, and can operate on a resource (e.g., a collection of information).

The various operations of example methods described herein may be performed, at least partially, by one or more processors 1302 that are temporarily configured (e.g., by software, code, and/or instructions stored in a machine-readable medium) or permanently configured to perform the relevant operations. Whether temporarily or permanently configured, such processors 1302 may constitute processor-implemented (or computer-implemented) modules that operate to perform one or more operations or functions. The modules referred to herein may, in some example embodiments, comprise processor-implemented (or computer-implemented) modules.

Moreover, the methods described herein may be at least partially processor-implemented (or computer-implemented) and/or processor-executable (or computer-executable). For example, at least some of the operations of a method may be performed by one or more processors 1302 or processor-implemented (or computer-implemented) modules. Similarly, at least some of the operations of a method may be governed by instructions that are stored in a computer readable storage medium and executed by one or more processors 1302 or processor-implemented (or computer-implemented) modules. The performance of certain of the operations may be distributed among the one or more processors 1302, not only residing within a single machine, but deployed across a number of machines. In some example embodiments, the processors 1302 may be located in a single location (e.g., within a home environment, an office environment or as a server farm), while in other embodiments the processors 1302 may be distributed across a number of locations.

While the embodiment(s) is (are) described with reference to various implementations and exploitations, it will be understood that these embodiments are illustrative and that the scope of the embodiment(s) is not limited to them. In general, the embodiments described herein may be implemented with facilities consistent with any hardware system or hardware systems defined herein. Many variations, modifications, additions, and improvements are possible.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the embodiment(s). In general, structures and functionality presented as separate components in the example configurations may be implemented as a combined structure or component. Similarly, structures and functionality presented as a single component may be implemented as separate components. These and other variations, modifications, additions, and improvements fall within the scope of the embodiment(s).

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles and their practical applications, to thereby enable others skilled in the art to best utilize the embodiments and various embodiments with various modifications as are suited to the particular use contemplated.

What is claimed is:

1. A computer-implemented method for presenting information to a user, comprising:
receiving information to be presented to the user, the information having a predetermined format;
obtaining an identifier for the user;
obtaining a visual acuity for the user using the identifier for the user;
adjusting the predetermined format based on the visual acuity of the user to produce an adjusted format; and
presenting the information to the user using the adjusted format.

2. The computer-implemented method of claim 1, wherein presenting the information to the user using the adjusted format includes:
identifying print settings based on the visual acuity of the user; and
printing objects corresponding to the information to be presented to the user on a document based on the print settings using a print device.

3. The computer-implemented method of claim 2, wherein identifying the print settings based on the visual acuity of the user includes:
determining dimensions of the document and a predetermined viewing distance of the document; and
identifying the print settings based on the dimensions of the document, the predetermined viewing distance of the document, and visual acuity of the user.

4. The computer-implemented method of claim 2, wherein printing the objects corresponding to information to be presented to the user on the document based on the print settings using the print device includes:
adjusting at least one of the objects based on the print settings; and
printing the at least one of the objects on a page of the document using the print device.

5. The computer-implemented method of claim 4, wherein the document includes a customer receipt printed during a sale transaction, and wherein adjusting the at least one of the objects based on the print settings includes adjusting an object on the receipt that includes information important to the user.

6. The computer-implemented method of claim 5, wherein the object on the receipt that includes information important to the user is selected from the group consisting of:
a total value line of the receipt; and
a customer signature line of the receipt.

7. The computer-implemented method of claim 2, wherein printing the objects corresponding to the information to be presented to the user on the document based on the print settings using the print device include:
determining, based on the print settings, that the objects corresponding to the information to be presented to the user on the document do not fit on a single page of the document;
generating multiple pages of the document to accommodate the objects corresponding to the information to be presented to the user; and
printing, using the print device, the objects corresponding to the information to be presented to the user across the multiple pages of the document based on the print settings.

8. The computer-implemented method of claim 1, wherein presenting the information to the user using the adjusted format includes:
identifying display settings based on the visual acuity of the user; and
displaying objects corresponding to the information to be presented to the user in a graphical user interface of a device based on the display settings.

9. The computer-implemented method of claim 8, wherein identifying the display settings based on the visual acuity of the user includes:
determining the specifications of a display device for the device and a predetermined viewing distance of the display device for the device;
identifying the display settings based on the specifications of the display device, the predetermined viewing distance of the display device for the device, and the visual acuity of the user.

10. The computer-implemented method of claim 8, wherein displaying the objects corresponding to the information to be presented to the user in the graphical user interface of the device based on the display settings includes:
adjusting at least one of the objects based on the display settings; and
displaying the at least one of the objects in a viewable area of the graphical user interface.

11. The computer-implemented method of claim 10, wherein displaying the at least one of the objects in the viewable area of the graphical user interface includes:
determining, based on the display settings, that the objects corresponding to the information to be presented to the user in the graphical user interface do not fit the viewable area of the graphical user interface; and
placing the objects corresponding to the information to be presented to the user in the graphical user interface across the viewable area of the graphical user interface and a scrollable area of the graphical user interface.

12. The computer-implemented method of claim 10, wherein displaying the at least one of the objects in the viewable area of the graphical user interface includes:
determining, based on the display settings, that the objects corresponding to the information to be presented to the user in the graphical user interface do not fit the viewable area of the graphical user interface;
generating multiple viewing pages of the graphical user interface to accommodate the objects corresponding to the information to be presented to the user in the graphical user interface; and
placing the objects corresponding to the information to be presented to the user in the graphical user interface across the multiple viewing pages of the graphical user interface.

13. The computer-implemented method of claim 1, wherein the identifier for the user is included on a personal identification object, and wherein obtaining the identifier for the user includes:
obtaining electronic data including the identifier for the user from the personal identification object.

14. The computer-implemented method of claim 13, wherein the personal identification object is selected from the group consisting of:
a credit card for the user;
a driver's license for the user;
a smartphone for the user;
a mobile phone of the user; and
an RFID tag for the user.

15. The computer-implemented method of claim 13, wherein obtaining the electronic data including the identifier for the user from the personal identification object includes obtaining the identifier for the user from the magnetic stripe of the credit card using a magnetic stripe reader.

16. The computer-implemented method of claim 13, wherein obtaining the electronic data including the identifier for the user from the personal identification object includes obtaining the identifier for the user from the magnetic stripe of the driver's license using a magnetic stripe reader.

17. The computer-implemented method of claim 13, wherein obtaining the electronic data including the identifier for the user from the personal identification object includes obtaining the identifier for the user from the RFID tag using an RFID reader.

18. The computer-implemented method of claim 1, wherein obtaining the visual acuity for the user using the identifier for the user includes obtaining the visual acuity for the user from a server.

19. A system to present information to a user, comprising:
a processor-implemented presentation module configured to:
receive information to be presented to the user, the information having a predetermined format; and
present the information to the user using an adjusted format;
a processor-implemented authentication module configured to obtain an identifier for the user; and
a processor-implemented vision module configured to:
obtain a visual acuity for the user using the identifier for the user; and
adjust the predetermined format based on the visual acuity of the user to produce the adjusted format.

20. A computer readable storage medium storing at least one program that, when executed by at least one processor, causes the at least one processor to perform operations comprising:
receiving information to be presented to the user, the information having a predetermined format;
obtaining an identifier for the user;
obtaining a visual acuity for the user using the identifier for the user;
adjusting the predetermined format based on the visual acuity of the user to produce an adjusted format; and
presenting the information to the user using the adjusted format.
